(19) United States
(12) Patent Application Publication
(10) Pub. No.: US 2015/0310292 A1
(43) Pub. Date: Oct. 29, 2015

(54) METHOD FOR DISPLAYING AND UPDATING OF DOCUMENTS DISPLAYED ON A USER INTERFACE

(71) Applicant: Targeteam Services and IT GmbH, Haigerloh (DE)

(72) Inventor: Antonie SCHMIDT, Munich (DE)

(21) Appl. No.: 14/699,836

(22) Filed: Apr. 29, 2015

(30) Foreign Application Priority Data
Apr. 29, 2014 (DE) 10 2014 106 007.5

(51) Int. Cl. G06K 9/20; H04L 29/06; G06F 17/30; G06F 3/0484

(52) U.S. Cl. CPC G06K 9/2054; G06F 3/0484; H04L 67/42; G06F 17/30345; G06F 17/30312

(57) ABSTRACT

A method for generating or updating of documents for visualization at a user interface is provided. In a database, the data sets to be displayed in the document are stored, wherein the data sets respectively comprise location information. A server means receives from the first client means a request message, selects from the database data sets according to search criteria, and embeds the selected data sets in a section of a map, wherein the map section is selected such that it comprises the location information of the selected data sets, and embeds a marker into the map section for each data set according to the location information, wherein the marker is linked to a data set logically, and an event trader is adapted to optically highlight the data set associated with the marker (or vice versa) upon a selection of a marker.

### CROSS REFERENCE TO RELATED APPLICATIONS

This application claims priority under 35 U.S.C. §119 to German Application No. 10 2014 106 007.5, filed Apr. 29, 2014, the contents of which are incorporated by reference herein.

### FIELD OF THE INVENTION

The invention relates to a method for generating and/or updating of documents for the visualization at a user interface at a client means, wherein the client means may be coupled or is coupled via a communication network to a server means, and the server means may be coupled or is coupled via the communication network to a number of further client means.

### BACKGROUND OF THE INVENTION

Methods for data transmission for transmitting documents from a server means to a number of client means and the display of the transmitted documents at the client means are known from prior art. Thus, it is, for example, known to transmit electronic documents, as Internet pages, from an Internet server (web server) to a number of Internet clients, and display them there, for example, in an Internet browser. Hereby, the documents are transmitted from the Internet server to the Internet clients, after the documents to be transmitted have been requested by the respective intended client. Such methods are, for example, employed with respect to Internet-based sales platforms, auction platforms, or collaboration platforms.

Regarding sales and auction platforms, it is desirable, if during the viewing of a desired product, the current price is displayed at this point of time, even if the price might change during the viewing. This is achieved by loading the website, at which the product and corresponding price are displayed, in certain intervals manually. Thereby, the entire website is transmitted to the intended client again such that the current price is being displayed.

With respect to collaboration platforms, different participants cooperate in a (virtual) project via client means assigned to them, wherein the client means respectively are connected to a server means. In order to enable an efficient cooperation, it is imperative that a modification at the project made by one participant is notified to the other participants.

An example for such a collaboration platform is a system for supporting a rental and sales process of real estate properties, according to which a company or all participants involved are able to control all phases of the rental and sales process. Such collaboration platforms for the rental and sales process, on the one hand, have to manage a large number of real estate properties. On the other hand, a prospective customer may be interested in a large number of real estate properties, which have to be displayed for the potential buyer or renter at his/her client means. Hereby, it is known to present the relevant real estate properties and the corresponding data to the potential buyer or renter such that the potential buyer or renter is able to compare the real estate properties and, if needed, to select a real estate property. Hereby, it is important that the potential buyer or renter may, for example, transmit information concerning the preferred real estate property to a real estate agent, or that the real estate agent may communicate changes concerning individual real estate properties, as a changing lease price, to the potential buyer or renter. This usually is carried out verbally or by mail.

A further disadvantage is that the interested buyer or renter has no overview where the real estate property is located exactly.

Therefore, it is an object of the present invention to provide a method which at least partially avoids the disadvantages described above, and by means of which objects managed by means of a collaboration platform, in particular, real estate properties for a rental or sales process, are visualized at a user interface of a client means in an improved manner in order to increase the readability, and, on the other hand, to obtain an improved overview over the locations of the objects. At the same time, the interactivity or the interactions between the participants of the collaboration platform should be improved such that changes, which are made by one participant are notified to the other participants, preferably in real time, wherein the further participants should not only be informed about the change having taken place, but rather also about what data exactly have been changed.

### SUMMARY

This object is solved according to the invention by a method for generating and/or updating of documents for the visualization at a user interface of a first client means according to the independent claim. Preferred embodiments and further developments of the invention are specified in the dependent claims.

Accordingly, a method for generating and/or updating of documents for the visualization at a user interface of a first client means is provided, wherein the first client means can be coupled to a server means via a communication network, wherein the server means via the communication network can be coupled to a number of second client means, and wherein a storage means is assigned to the server means, in which information in the document to be displayed is stored as data sets, wherein the data sets respectively comprise location information and detail criteria assigned to the location information, wherein the server means
receives, from the first client means, a request message by means of which the server means is requested to generate a document according to a number of search criteria, wherein the search criteria are stored in the storage means,
determines and selects those data sets in the storage means, which at least partially correspond to the search criteria,
embeds a map section into the document, wherein the map section is selected such that it comprises the location information of the selected data sets,
embeds, into the map section, a marker for each selected data set, wherein the position of the markers in the map section corresponds to the respective location information of the data set,
embeds, into the document, a result list comprising lines and columns, wherein the selected data sets are respectively assigned to a line or column, wherein the lines or columns respectively comprise a number of detail criteria, and

transmits the document to the first client means,

wherein
a marker is linked to a column or to a line of the result list logically, and
an event handler is respectively assigned to the markers and to the lines or columns of the result list, which is adapted to
upon selection of a marker at the user interface, at the user interface optically highlight the line or column of the result list linked to the selected marker and/or
upon selection of a line or column of the result list at the user interface, optically highlight the marker at the user interface linked to the selected line or column of the result list.

Thereby, the document is advantageously structured such that due to the improved readability of the document, a user obtains an overview over the geographic location of the objects listed in the result list in a simple manner, wherein the user by selecting a marker or by selecting a line or column immediately is informed about which line or column or which marker is assigned to the selected marker or to the selected line or column. Thereby, in particular, a technical solution is provided enabling an efficient search and an efficient comparison of the objects displayed in the document.

According to an embodiment of the method according to the invention, for each determined data set, a correspondence value may be determined being indicative for to which degree the respective data set corresponds to the search criteria, and the lines or columns of the result list may be sorted according to the determined correspondence value, preferably, in descending order.

Thereby, a decision process of a user for the selection of an object may be supported even better.

According to a preferred embodiment, a second event handler is respectively assigned to the lines or columns of the result list, which is adapted to displace a line or column in the result list selected at the user interface to the end or to the beginning of the result list.

According to an embodiment of the invention, the second event handler may be assigned to a button.

According to an embodiment of the invention, during the execution of the second event handler at the first client means, the server means may receive an update notification from the first client means, which comprises information on which column or which line of the result list has been displaced to the end or to the beginning of the result list at the user interface of the first client means.

It is preferred, if the server means generates an updated message after receipt of the update notification, and transmits it to that second client means, to which a document has also been transmitted having

a line or a column of the result list, which has been displaced at the first client means, wherein the update message comprises information on which column or which line of the result list at the user interface of the first client means has been displaced to the end or to the beginning of the result list, wherein a program code is embedded into the document, which is adapted to be executed at the user interface of the second client means, and to displace at the user interfaces of the second client means, the line or column indicated in the update message to the end or to the beginning of the result list.

Thereby, a column or a line of the result list is also displaced at all second client means correspondingly after the displacement at the first client means, as far as the displaced line or column is also displayed at the second client means. Thereby, all users are informed with respect to the displacement of a line or a column in the result list nearly in real time.

In a preferred embodiment of the invention, the server means may
receive a modification notification from at least one of the second client means comprising information on which detail criteria of which data sets have been modified at the second client means,
update the corresponding data set in the storage means with modified detail criteria,
generate a modification notification, which comprises an identifier of the modified data set and identifiers of the modified detail criteria, and
transmit the modification notification to the first client means, wherein a program code is embedded, which is adapted to be executed at the first client means, and at the first client means
to optically highlight the marker assigned to the identifier of the modified data set and/or
to update and/or to optically highlight the items of the result list assigned to the identifiers of the modified detail criteria with the values of the modified detail criteria.

Thereby, after a modification of data at the user interface of a first client means, the users of the second client means are not only informed on which objects have been modified, but rather also on which detail criteria (for example, attributes or values) exactly have been modified in the respective objects. Thereby, the interaction between the participants is even further improved, because by optically highlighting the modifications at the user interface of the client means, the users immediately obtain information on which detail criteria exactly have been changed.

Hereby, the modification of detail criteria of a data set may comprise:

updating a value of an attribute of a data set,

deleting a value of an attribute of a data set,

adding or writing a new attribute of a data set,

adding a document to a data set, for example, by means of an upload,

removing a document from a data set, and/or

updating the document added to the data set.

Hereby, a document may be an electronic document, for example, a PDF file or a data set.

Further, it is advantageous, if the server means
receives an evaluation notification from at least one second client means comprising an identifier of a line or a column of the result list visualized at the second client means, and a rating value assigned to the line or column,
generates, from the received rating value and the rating values stored in the storage means and assigned to the received identifier, a cumulated rating value,
generates an evaluation message, which comprises the received identifier and the cumulated rating value, and transmits the evaluation message to the first client means and to the second client means,

wherein a program code is embedded in the document being adapted to be executed at the client means, and to replace a rating value displayed at the client means and assigned to the received identifier by the cumulated rating value.

Thereby, when modifying a rating of an object, all client means are immediately provided with the cumulated rating value, and it is displayed in the document.

The program code may further be adapted to sort a number of the lines or the columns of the result lists displayed at the client means according to the cumulated rating value, preferably, to sort in a descending order. Thereby, the degree of the interaction is even further increased.

The program codes mentioned above may be embedded into the respective document during the generation of the document or during the generation of the documents by the server means, and may be transmitted together with the document to the respective client means. Alternatively, it may be provided for the program codes being transmitted to the client means and to embed them on the client side into the document only after the server means has received the corresponding notification. Hereby, it may be advantageous to transmit the respective program code together with the respective message to the client means. Thereby, the data volume to be transmitted may at first be substantially reduced, and the respective program code is transmitted only if it is requested from the client means by means of a notification.

According to an embodiment of the invention, the location information comprises geo-coordinates, wherein the detail criteria assigned to the location information or to the geo-coordinates comprises information on the real estate property.

The search criteria may comprise at least one criterion from the group comprising region, district, vicinity with respect to a geo-coordinate, minimum area, maximum area, minimum price, maximum price, facilities and combinations hereof.

According to a preferred embodiment of the invention, when determining the correspondence value, the search criteria may be weighted differently. For example, the maximum price may be incorporated into the correspondence value with a weighting of 55% and the facilities with a weighting of 30%. This means that the maximum price has a stronger influence than the facilities for the determination of the correspondence value.

The document, which is transmitted to the client means may be an HTML document or the user interface which may be presented in an app of a mobile terminal.

According to a further preferred embodiment of the invention, the server means may receive via an interface, preferably, an XML interface, data packets, preferably XML packets, comprising the location information and the detail criteria assigned to the location information, store the information contained in the received data packets in the storage means and/or update the information stored in the storage means and transmit the modified detail criteria to the first and/or to the second client means in real time, as far as the modified detail criteria are displayed at the first and/or at the second client means.

According to the inventive method, in particular, a collaboration platform for the rental and sales process of real estate properties may be provided, which enables an improved interaction between the participants of a rental and sales process, and at the same time, guarantees an improved readability and operability of the objects displayed at the user interface of the participants.

### BRIEF DESCRIPTION OF THE DRAWINGS

Further details and features of the invention as well as concrete technical embodiments and advantages of the invention can be derived from the following description in connection with the drawing, in which:

FIG. 1 shows a system for the execution of the inventive method;

FIG. 2 shows an example of a user interface with a document, which has been generated according to the inventive method, and which may be updated according to the inventive method;

FIG. 3 shows a sequence diagram of the method according to the invention for illustration of a possible sequence for the generation and update of a document.

### DETAILED DESCRIPTION OF THE PREFERRED EMBODIMENTS

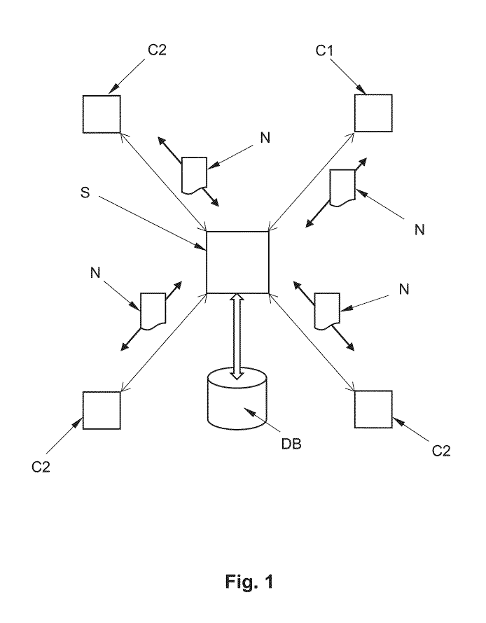

FIG. 1 shows a system, which is adapted or suitable for executing the inventive method.

The system comprises a server means S, a first client means C1, and a number of second client means C2, wherein the client means C1, C2 are coupled to the server means S via a communication network. According to the inventive method, documents are generated by the server means S and are transmitted to the client means C1, C2. Further, messages or notifications N are transmitted or exchanged between the server means S and the client means C1, C2 according to the inventive method in order to manage and update of the documents being displayed at the client means C1, C2.

Further, the server means S is coupled to a data storage or to a storage means DB, in which the objects or data sets are stored, which are being visualized in the documents being displayed at the client means C1, C2.

According to an embodiment of the invention, the server means S may be configured as an Internet server or a web server, wherein the documents transmitted from the server means S to the client means C1, C2 comprise HTML documents. The documents transmitted to the client means C1, C2 may be displayed there at a user interface, wherein the user interface, for example, may comprise an Internet browser. Alternatively, the documents may be part of a user interface of an app executable at the client means, wherein the client means may comprise mobile terminals. In case of an app, the document to be transmitted to the client means only comprises the data to be visualized at the client means, while formatting of the data or the graphical processing of the document is carried out by the app. With respect to the generation and/or the updating of a document according to the method according to the invention, the procedure when using an app is identical to the procedure when using an HTML document, which is displayed in an Internet browser.

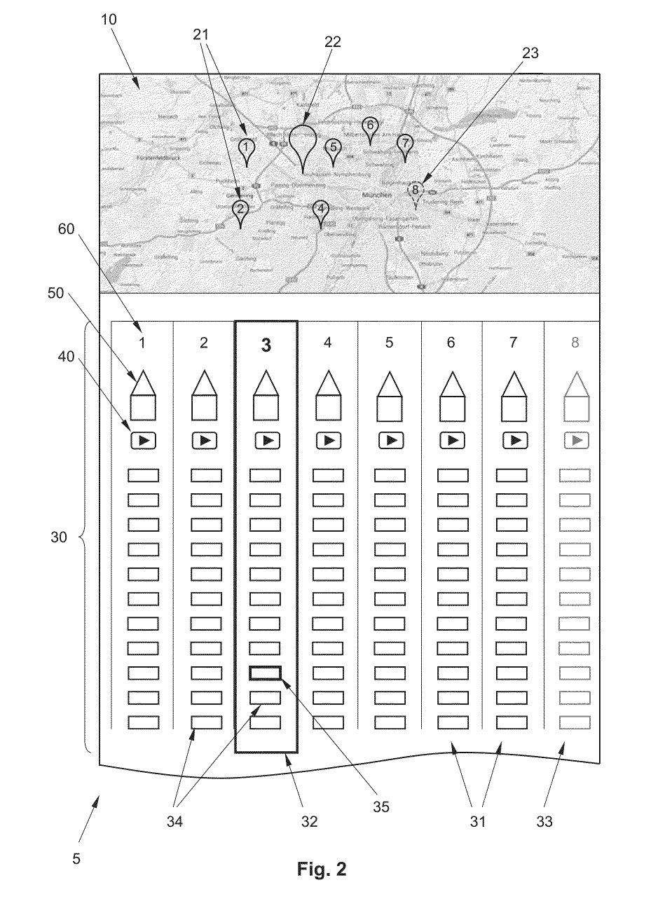

FIG. 2 shows a document 5 configured as a website, which is being displayed at an Internet browser of a terminal or of a client means.

According to the invention, the document 5 is generated by a server means, as for example a web server, and is transmitted to the client means, wherein the document 5 is generated according to a number of search criteria, which are stored in the storage means. In the document 5, the search results corresponding to the search criteria are embedded, wherein in the present example, the data sets of the search result are displayed as columns 31 of a result list.

With respect to the search results or data sets, in the document shown in FIG. 2, real estate or real estate properties are concerned, which are in a rental and/or selling or sales process.

Real estate or real estate properties are characterized by being located at a certain geographical location. For improvement of the operability and for improvement of the navigation and for a faster acquisition of the locations of the objects in the result list 30, according to the invention, a map 10 or map section of the city or a geographical map is embedded in the document 5. Thereby, the map section 10 is selected such that all real estate or real estate properties listed in the result list 30 are within the map section. Thereby, it is guaranteed that individual real estate or real estate properties are not located outside of the map section, and therefore are not considered or are only difficult to determine by the user of the system.

Each data set or each real estate property from the result list 30 is assigned to location information, for example, a geo-coordinate or geocode. By means of this geocode or geo-coordinate, the server means, when generating the document 5, embeds markers 21 in the map section 10, wherein each marker 21 is assigned to an object of the result list 30. By this assignment, it is enabled that the user, for example, may select or activate a marker 22, wherein at the same time the column 32 of the result list 30 assigned to the selected marker 22 is optically highlighted. Thereby, the user may select the data sets assigned to the marker from the result list by selecting a marker in a simple manner. Vice versa, it is also possible to select or to activate a column 32 of the result list 30, wherein at the same time the marker 22 assigned to the selected column 32 is optically highlighted. Thereby, it is enabled in a particularly advantageous manner to select objects assigned to a geographical location or to display the geographical location assigned to an object.

In order to accomplish the optical highlighting of a marker assigned to a selected column or a column assigned to a selected marker, a program code is embedded in document 5, which comprises an event handler, which is assigned to the markers or to the columns, and which monitors the user actions with respect to the markers or to the columns, and which, if needed, executes a program code for highlighting the marker or the column optically.

This program code may be embedded in the document 5 by the server means, prior to the document being transmitted to the client means. Alternatively, this program code may be reloaded as soon as the user selects a column and/or a marker.

The marker, here, comprises an ordinal number being identical to the ordinal number 60 of the column 31 assigned to the respective marker.

Here, the result list 30 comprises a number of columns 31, wherein the columns 31 respectively represent a data set, wherein the data sets displayed in the document 5 are the result of a search request. The search criteria for the search request may be stored according to an embodiment of the invention in the storage means DB. Each column 31 or the data sets being displayed in the respective column comprise a number of items 34, which are displayed line by line such that the same attributes of adjacent columns are within the same line. Thereby, a comparison of the objects displayed in the columns is facilitated.

Alternatively, the results of the search request or the data sets may also be arranged in lines.

An image of the object is assigned to each data set, which also is inserted into the document 5 by the server means.

Further a button 40 is assigned to each column 31, wherein when manipulating a button 40 of a column 31, the corresponding column is displaced to the end of the result list 30, wherein a column 33 displaced to the end of the result list 30 may be hidden or blanked out. It is preferable, if also the marker 23 belonging to the column 33 which has been displaced to the end, is also blanked out or is displayed differently to the other markers.

A further button may be assigned to each column 31, by means of which the respective column may be displaced to the beginning of the result list 30. The corresponding marker may also be presented differently from the other markers.

FIG. 2 shows a field 35 of the data set of the column 32, which is optically highlighted. In case the data set assigned to the column 32 is transmitted with the inventive document to another client and is displayed there, and if this data set is modified at the other client means by the user, the modifications are transmitted to the client means, at which document 5 shown in FIG. 2 is being displayed, and is marked there for the user by optically highlighting the modified field 35 and the initial value is replaced by the modified value. Additionally, also the column, to which the data set with the modified field 35 is assigned, may be highlighted optically. Thereby, the readability with respect to modified objects of fields is increased such that the user may recognize the modifications at one glance.

The columns or data sets contained in the result list 30 representing a result of a search request may be sorted according to a predetermined sorting criterion. For example, as sorting criterion a correspondence value may be provided, which is determined for each data set of the result list 30 and which indicates to which degree the respective data set corresponds to the search criteria. The server means may then sort the columns of the result list during embedding the result list 30.

Further, for each data set the possibility may be provided to evaluate the latter or to display for each data set a rating or a rating value. The rating or the rating value may be used as an alternative or additional sorting criterion for sorting the result list 30. In case a user of a second client means adds a rating or this user modifies a rating of a data set, which is being displayed at the first client means as well as at the second client means, the rating value modified by the user of the second client means is transmitted to the server means, which determines from the received rating value and the rating values already stored in the storage means with respect to this data set, a cumulated rating value and transmits it to the first client means, where the cumulated rating value displayed there is replaced by the new cumulated rating value. As far as the cumulated rating value is provided as sorting criterion of the result list 30, and the new cumulated rating value should lead to re-sorting of the result list 30, it may be advantageous, if a program code is embedded in the document 5, which carries out the re-sorting of the result list 30.

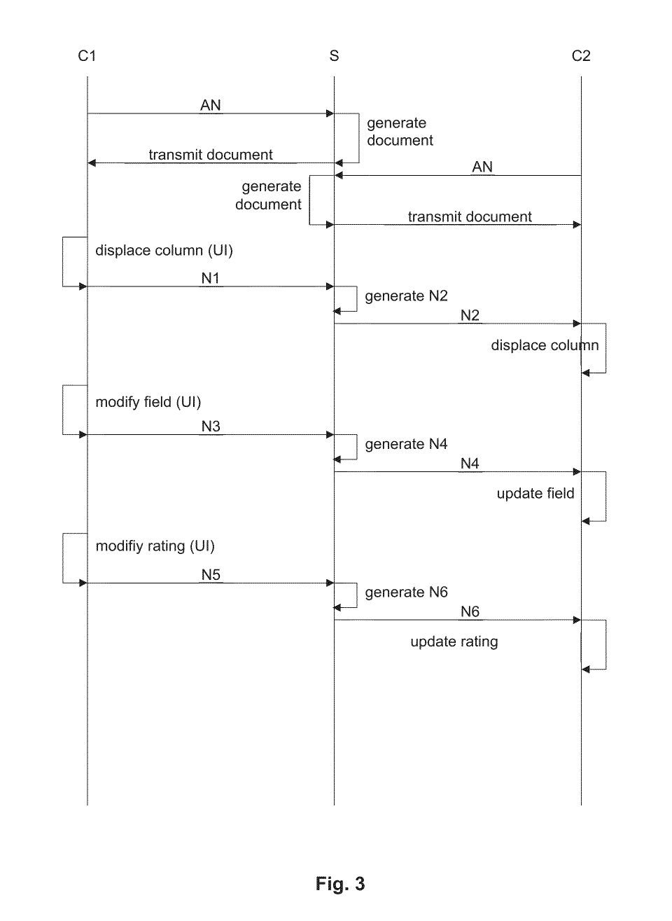

FIG. 3 shows a sequence diagram for an exemplary sequence of the inventive method.

At first, a request message AN is transmitted from the first client means C1 to the server means S, which requests a document, in which the objects are displayed, which correspond to a number of search criteria stored in the storage means. Thereupon, the server means generates a corresponding document, in which the map 10, the marker 21, and the result list 30 are embedded, and transmits the generated document to the first client means C1, where it is being displayed at a user interface.

A second client means C2 also requests from the server means S a document by transmitting a corresponding request message AN to the server means S, wherein according to the present example, it is assumed that the document to be generated by the server means S for the client means C2 is generated on the basis of the same search criteria. After the server means S has also generated the second document, which due to the same search criteria is identical to the document transmitted to the first client means C1, this document is transmitted to the second client means C2 and there, it is being displayed at a user interface.

According to the sequence shown in FIG. 3, a user interaction takes place at the first client means C1, according to which a column of the result list 30 is being displaced to the end of the result list. Hereby, at the first client means C1, an update notification N1 is generated and is transmitted to the server means S. The update notification N1 comprises information on which column of the result list 30 at the first client means C1 has been displaced to the end of the result list. Moreover, the update notification N1 comprises information on whether the column has been displaced to the end or to the beginning of the result list.

The server means S receives the update notification N1, evaluates the latter, and subsequently generates an update message N2, which is transmitted from the server means S to the second client means C2. The update message N2 substantially comprises the same information as the update notification N1. By means of the update message N2, the second client means C2 is informed on which column of the result list has been displaced to the end or to the beginning of the result list. The second client means C2 evaluates the information contained in the update message N2, and displaces the corresponding column according to the update message to the end or to the beginning of the result list. For this, the document has a program code, which is executed after receipt of the update message N2 to the second client means C2, and which displaces the column correspondingly. In case of an HTML document, this program code may be a JavaScript module or JavaScript code. This program code may have been inserted into the document during generation of the document by the server means S. Alternatively, the program code may be transmitted together with the update message N2 to the second client means C2. This also applies for the subsequently mentioned program codes, which are being executed at the second client means C2.

According to the sequence shown in FIG. 2, the first client means C1 receives a further user input at the user interface, by means of which the field of a data set has been modified at the first client means C1. The modification, for example, may have been carried out in the result list directly. Alternatively, the modification may have been carried out, as the corresponding data set or the corresponding column of the result list has been opened in a detailed view.

After modification of the field, the first client means C1 generates a modification notification N3, and transmits it to the server means S. The modification notification N3 substantially comprises information on which field or which fields have been modified in which data set.

The server means S receives the modification notification N3, evaluates it, and generates a modification message N4, which subsequently is transmitted to the second client means C2. The modification message N4 substantially comprises the same information as the modification notification N3 such that the second client means C2 is informed on which field or which fields of which data set have been modified. Additionally, also the values of the modified fields are transmitted with the modification message N4, in order to replace at the second client means C2 the initial values of the modified fields by the new values.

Additionally, the server means S, after receipt of the modification notification N3 performs an update of the data storage or of the data set stored in the storage means DB.

After receipt of the modification message N4, the second client means C2 executes a program code, by means of which the fields are updated according to the modification message N4. Also here, the program code may already be inserted into the document during generation of the document by the server means S. Alternatively, the program code may be transmitted together with the modification message N4 to the client means C2.

In the next step, according to the sequence diagram shown in FIG. 3, the rating of a data set is modified at the first client means C1, resulting from a user interaction or user input. The modified rating of a data set is transmitted together with an evaluation notification N5 to the server means S, whereby the evaluation notification N5 comprises an identifier of a data set or the column as well as the rating value assigned to the data set, wherein this assigned rating value is the new rating input by the user.

After receipt of the evaluation notification N5, the server means S generates from the received rating value and the rating values stored in the storage means and assigned to the received identifier, a cumulated rating value. From the cumulated rating value and the received identifier, which identifies the data set, an evaluation message N6 is generated and is transmitted to the second client means C2.

The second client means C2 receives the evaluation message N6, and executes a program code embedded in the document or transmitted together with the evaluation message N6, by means of which for the data set indicated in the evaluation message N6 at the second client means C2, the cumulated rating value displayed there is replaced by a cumulated rating value indicated in the evaluation message N6.

The method shown in the sequence diagram according to FIG. 3 may also be carried out with a plurality of second client means C2, whereby the messages N2, N4, and N6 respectively are transmitted to such second client means C2, which display a data set, which has been modified at the first client means C1. Thereby, it is guaranteed that all client means after a modification of a data set at one of these client means display at any point of time the current state of the data sets. By the provision of notifications N1, N3, and N5, as well as by the provision of the messages N2, N4, and N6, on the one hand, the data volume to be transmitted is substantially reduced, because thereby it is prevented that documents being displayed at the respective client means after each modification of a data set do not have to be reloaded completely. For the transmission of the messages N2, N4, and N6, it is advantageous, if these are transmitted by the server means S according to a push process to the client means. Thereby, it is avoided that the corresponding client means have to send requests to the server means, by means of which the presence of these messages at the server means is queried.

Further, according to the inventive method it is provided that the search criteria stored in the storage means DB are generated or defined at one of the client means, and are transmitted to the server means S. The storage of the search criteria in the server means S has the advantage that for a rental or sales process of real estate or real estate properties, all users involved in a project are provided with an identical search result.

### REFERENCE NUMERALS

5 result page (e.g., website)

10 map or map section (city or geographical map)

21 marker, e.g., pins

22 selected or activated marker

23 inactive or deactivated marker

30 result list

31 columns of the result list 30 (substantially corresponding to a data set)

32 selected or activated column of the result list 30

33 inactive or deactivated column of the result list 30

34 items (lines) of columns 31

35 modified field of column 31

40 button (e.g. a button or link)

41 button (e.g. a button)

50 image

60 ordinal number

AN request message

C1 first client means

C2 second client means

DB database

N message or notification

N1 update notification

N2 update message

N3 update notification

N4 update message

N5 evaluation notification

N6 evaluation message

What is claimed is:

1. A method for generating or updating of documents for visualization at a user interface of a first client means, wherein the first client means can be coupled to a server means via a communication network, wherein the server means can be coupled to a number of second client means via the communication network, and wherein a storage means is assigned to the server means, in which the information to be displayed in the document is stored as data sets, wherein the data sets respectively comprise location information and detail criteria assigned to the location information, wherein the server means
receives, from the first client means, a request message, by means of which the server means is requested to generate a document according to a number of search criteria, wherein the search criteria are stored in the storage means,
determines and selects, in the storage means, those data sets corresponding at least partially to the search criteria,
embeds, in the document, a section of the map, wherein the map section is selected such that it comprises the location information of the selected data sets,
embeds, in the map section, for each selected data set a marker, wherein the position of the marker in the map section corresponds to the respective location information of the data set,
embeds, in the document, the result list comprising lines and columns, wherein the selected data sets respectively are assigned to a line or to a column, wherein the lines or the columns respectively comprise a number of detail criteria of the data sets assigned to them, and
transmits the document to the first client means,
wherein
a marker is linked to a column or to a line of the result list logically, and
an event handler is respectively assigned to the markers and the lines or columns of the result list, which is adapted to
upon selection of a marker at the user interface, optically highlight the line or column of the result list at the user interface, the line or column of the result list linked to the selected marker, or
upon selection of a line or column of the result list at the user interface, optically highlight the marker at the user interface linked to the selected line or column of the result list.

2. The method of claim 1, wherein for each determined data set, a correspondence value is determined being indicative for to which degree the respective data set corresponds to the search criteria, and wherein the lines or columns of the result list are sorted according to the determined correspondence value.

3. The method of claim 1, wherein the lines or columns of the result list respectively are assigned to a second event handler, which is adapted to displace a line or column of the result list to the end or to the beginning of the result list selected at the user interface.

4. The method of claim 3, wherein the second event handler is assigned to a button.

5. The method of claim 3, wherein during the execution of the second event handler at the first client means, the server means receives an update notification from the first client means, which comprises information on which column or which line of the result list at the user interface of the first client means has been displaced to the end or to the beginning of the result list.

6. The method of claim 5, wherein the server means after receipt of the update notification, generates an update message, and transmits it to those second client means, to which also a document has been transmitted comprising a line or a column of the result list, which has been displaced at the first client means, wherein the update message comprises information on which column or which line of the result list has been displaced to the end or to the beginning of the result list at the user interface of the first client means, wherein a program code is embedded in the document being adapted to displace at the user interfaces of the second client means, the line or column indicated in the update message to the end or to the beginning of the result list.

7. The method of claim 1, wherein the server means:
receives a modification notification from at least one of the second client means comprising information on which detail criteria of which data set have been modified at the second client means,
updates the corresponding data set in the storage means with the modified detail criteria,
generates a modification message, which comprises an identifier of the modified data set and identifiers of the modified detail criteria, and
transmits the modification message to the first client means, wherein a program code is embedded in the document being adapted to
optically highlight the marker assigned to the identifier of the modified data set or
with the values of the modified detail criteria, to update or optically highlight the items of the result list assigned to the identifiers of the modified detailed criteria
at the first client means.

8. The method of claim 1, wherein the server means:
receives an evaluation notification from at least one second client means, which comprises an identifier of a line or a column of the result list visualized at the second client means and a rating value assigned to the line or column,
generates from the received rating value and the rating values stored in the storage means and assigned to the received identifier, a cumulated rating value,
generates an evaluation message, which comprises the received identifier and the cumulated rating value, and transmits the evaluation message to the first client means and to the second client means,
wherein a program code is embedded in the document being adapted to replace a rating value assigned to the received identifier and displayed at the client means by the cumulated rating value.

9. The method of claim 8, wherein the program code is further adapted to sort a number of the lines or the columns of the result lists displayed at the client means according to the cumulated rating value.

10. The method of claim 1, wherein the location information comprises geo-coordinates, and wherein the detail criteria assigned to the location information comprises information on a real estate property.

11. The method of claim 1, wherein the search criteria comprise at least one criterion selected from the group comprising a region, district, vicinity of a geo-coordinate, minimum area, maximum area, minimum price, maximum price, facilities, and combinations hereof.

12. The method of claim 2, wherein during determination of the correspondence value, the search criteria are weighted differently.

13. The method of claim 1, wherein the document is an HTML document or a user interface which may be displayed in an app of a mobile terminal.

14. The method of claim 1, wherein the server means receives via an interface, preferably an XML interface, data packets, preferably XML packets, comprising location information and detail criteria assigned to the location information, stores the information contained in the received data packets in the storage means or updates the information stored in the storage means, and transmits modified detail criteria to the first or to the second client means in real-time, as far as the modified detail criteria are displayed at the first or at the second client means.
